(19) United States
(12) Patent Application Publication
(10) Pub. No.: US 2005/0259091 A1
(43) Pub. Date: Nov. 24, 2005

(54) Light-emitting element drive circuit

(76) Inventor: Hiroshi Sakamoto, Yokohama (JP)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/977,164

(22) Filed: Oct. 29, 2004

(30) Foreign Application Priority Data
May 24, 2004 (JP) 2004-153473

(51) Int. Cl. G09G 3/06

(52) U.S. Cl. 345/204

(57) ABSTRACT

A laser diode drive circuit that yields a steady optical waveform even when the illumination characteristic of a light-emitting element changes has a first S/H circuit that acquires a monitor voltage (OFF level) that prevails when a laser diode is extinguished. A second S/H circuit acquires a monitor voltage (ON level) that prevails when the laser diode is illuminated. An LPF acquires an average monitor voltage value (monitor average value). A duty feedback circuit calculates an intermediate value (normal average value) from the OFF level monitor voltage, ON level monitor voltage, and duty ratio (50%), and outputs a duty ratio control signal so that the monitor average value coincides with the normal average value. A duty control circuit controls an illumination current by controlling the waveform of data Txc in accordance with the duty ratio control signal.

### BACKGROUND OF THE INVENTION

The present invention relates to a light-emitting element drive circuit, and more particularly to a drive circuit suitable for a laser diode drive circuit.

It is difficult to maintain the oscillation output of a laser diode constant because of manufactured product variations, changes in the temperature characteristic, and aging-induced changes in the other characteristics. Therefore, dedicated driver circuits, as well as the adjustment function and adjustment process for initial value setup are required. However, it is necessary to select a dedicated driver circuit in such a manner that its adjustment range agrees with the laser diode variation characteristic. Due to such selection, the yield decreases, thereby increasing the cost. Particularly when high speed is specified, the requirements specifications are so stringent that it is necessary to obtain the specified performance in the adjustment process.

An automatic output control circuit (APC circuit: Auto Power Control circuit) is usually used to control the laser diode drive current (refer, for instance, to JP-A No. 324239/2003) in order to compensate for oscillation output changes that are caused by changes in the laser diode characteristics.

FIG. 5 illustrates an electrical block circuit for the automatic output control circuit. In FIG. 5, a drive current (Ip+Ib), which is an aggregate of a bias current Ib controlled by a bias current drive circuit 52 and an illumination current Ip controlled by a data current drive circuit 53, is supplied to a laser diode 51. The bias current drive circuit 52 controls the bias current Ib, which coincides with a threshold current at which the laser diode 51 begins to illuminate. The data current drive circuit 53 controls the illumination current Ip in accordance with data Tx. Therefore, the laser diode 51 illuminates in response to the illumination current Ip, which is output from the data current drive circuit 53, that is, in response to data Tx. FIG. 6 shows a timing diagram concerning data Tx, drive current (Ip+Ib), and optical output Po.

A monitor photodiode 54 receives light from the laser diode 51, and outputs a monitor current Im, which corresponds to an optical output Po that is received. The monitor current Im of the monitor photodiode 54 is output to a shunt resistor R. A feedback circuit 55 inputs a monitor voltage that is proportional to the monitor current Im applied to the shunt resistor R, and then compares the input monitor voltage against an initial setting that is defined, for instance, prior to product shipment.

If the characteristics of the laser diode 51 change due, for instance, to aging or temperature changes so that the optical output Po for the drive current (Ip+Ib) decreases, the monitor current Im also decreases accordingly. If the monitor voltage changes and fails to agree with the initial setting, the feedback circuit 55 outputs a first control signal CS1 to the bias current drive circuit 52 and a second control signal CS2 to the data current drive circuit 53 in order to ensure that the monitor current Im coincides with an initially defined current.

The bias current drive circuit 52 adjusts the value of the bias current Ib in accordance with the first control signal CS1. The data current drive circuit 53 adjusts the value of the illumination current Ip in accordance with the second control signal CS2. When the bias current Ib and illumination current Ip are adjusted, that is, when the drive current (Ip+Ib) is adjusted, the optical output Po is adjusted in the laser diode 51. This stabilizes the optical output Po.

The influence of laser diode deterioration or the like is exerted not only on the intensity of the optical output Po but also on the others. If, for instance, the illumination characteristic changes due to laser diode deterioration, delayed illumination may result. In such an instance, the illumination timing varies from the initial setting. For example, the rise of the optical output Po of the laser diode in which delayed illumination has occurred is delayed behind the normal optical output Po as shown in FIG. 6. Meanwhile, if the timing change in the fall of the optical output Po differs from the timing change in the rise, the High-level width of the optical waveform narrows (the optical waveform becomes thin).

The present invention has been made to solve the above problems and provides a laser diode drive circuit that yields a steady optical waveform even when the illumination characteristic of a light-emitting element changes.

### SUMMARY OF THE INVENTION

The present invention is a light-emitting element drive circuit in which light-emitting element drive means for driving a light-emitting element in accordance with an input signal is provided and duty ratio data is recorded. The light-emitting element drive circuit according to the present invention comprises detection light-sensitive element for detecting the intensity of light emission from the light-emitting element and outputting a detection signal in accordance with the detected intensity; extinguishment monitoring means for acquiring a first monitor value, which represents a detection signal that is generated when the light-emitting element is extinguished; illumination monitoring means for acquiring a second monitor value, which represents a detection signal that is generated when the light-emitting element is illuminated; average intensity acquisition means for acquiring a monitor average value of detection signals of the light-emitting element; and control means for calculating a normal average value from the first monitor value, the second monitor value, and the duty ratio, and controlling the light-emitting element drive means so that the monitor average value coincides with the normal average value.

According to the present invention described above, the normal duty ratio can be maintained even when the illumination timing varies due to changes in the illumination characteristic of the light-emitting element. In the light-emitting element drive circuit described above, the control means changes the illumination time of the light-emitting element so that the monitor average value coincides with the normal average value.

According to the present invention described above, the illumination time of the light-emitting element can be adjusted so that the monitor average value coincides with the normal average value. In the light-emitting element drive circuit described above, the light-emitting element drive means is controlled in accordance with the second monitor value acquired by the illumination monitoring means to control the intensity of light emission from the light-emitting element.

According to the present invention described above, the intensity of light emission from the light-emitting element can be controlled in accordance with a detection signal that is generated when the light-emitting element is illuminated. The light-emitting element drive circuit described above comprises bias drive means for outputting a bias current to the light-emitting element. The bias drive means is controlled in accordance with the first monitor value acquired by the illumination monitoring means to control the bias current.

According to the present invention described above, the bias current can be controlled in accordance with a detection signal that is generated when the light-emitting element is extinguished. The light-emitting element drive circuit described above comprises duty ratio acquisition means for acquiring duty ratio data.

According to the present invention described above, the data about a duty ratio can be acquired to exercise control in order to achieve the duty ratio. Therefore, a desired duty ratio can be set as needed to achieve such a duty ratio.

The present invention makes it possible to obtain a steady optical waveform even when the illumination characteristic of a light-emitting element changes.

### BRIEF DESCRIPTION OF THE DRAWINGS

FIG. 1 illustrates an electrical block circuit for a laser diode drive circuit according to the present invention.

FIG. 2 is a timing diagram that illustrates the operations of component circuits for a laser diode drive circuit according to the present invention.

FIG. 3 illustrates an optical output that is generated when an illumination delay is encountered as well as an average optical output value.

FIG. 4 is a timing diagram illustrating operations that are performed in relation to an illumination delay.

FIG. 5 illustrates an electrical block circuit for a conventional automatic output control circuit.

FIG. 6 is a timing diagram that illustrates the operations of component circuits for a conventional automatic output control circuit.

### DETAILED DESCRIPTION OF THE INVENTION

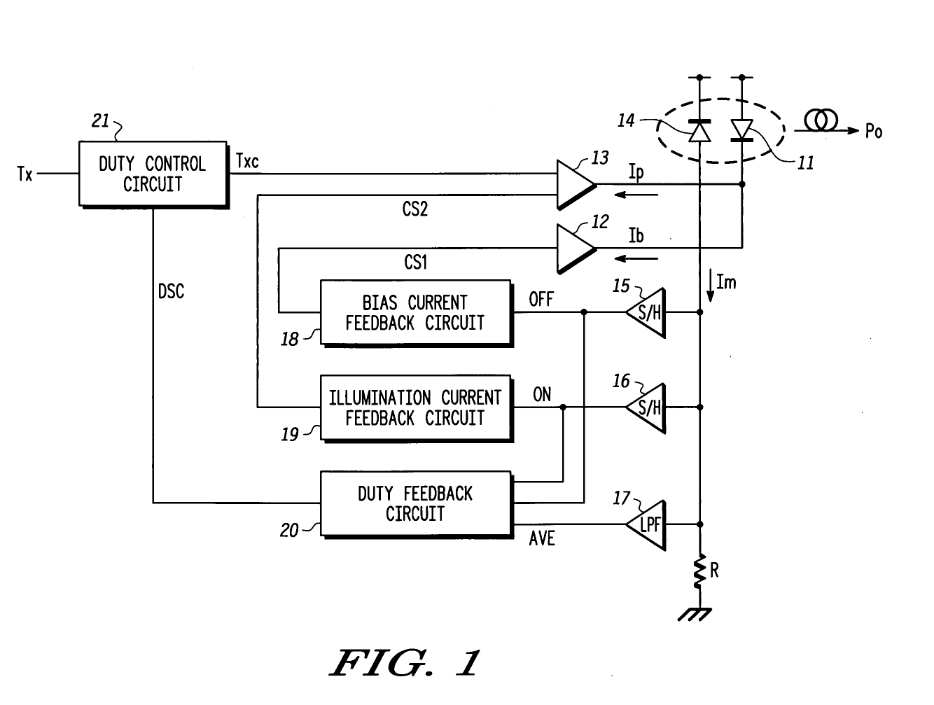

One embodiment of a laser diode drive circuit, which is based on a light-emitting element drive circuit according to the present invention, will now be described with reference to FIGS. 1 through 4. FIG. 1 is an electrical block circuit for the laser diode drive circuit.

As shown in FIG. 1, the laser diode drive circuit comprises a laser diode 11, which serves as a light-emitting element. The laser diode 11 is connected to a bias current drive circuit 12 and a data current drive circuit 13. A drive current (Ip+Ib) is supplied to the laser diode 11. The drive current is the sum of a bias current Ib, which is controlled by the bias current drive circuit 12, and an illumination current Ip, which is controlled by the data current drive circuit 13. The bias current drive circuit 12, which serves as bias drive means, controls the bias current Ib for a threshold current at which the laser diode 11 begins to illuminate.

Meanwhile, the data current drive circuit 13, which serves as light-emitting element drive means, controls the illumination current Ip in accordance with data Txc for illuminating the laser diode 11. The data current drive circuit 13 is connected to a duty control circuit 21. The data current drive circuit 13 controls the illumination current Ip in compliance with data Txc, which is entered from the duty control circuit 21.

The duty control circuit 21 controls the output of data Txc in accordance with data Tx, which is entered into the laser diode drive circuit. The laser diode drive circuit also comprises a monitor photodiode 14, which serves as a detection light-sensitive element. The monitor photodiode 14 receives light from the laser diode 11 and outputs a monitor current Im, which serves as a detection signal corresponding to an optical output Po that is received.

The monitor photodiode 14 is grounded via a shunt resistor R. The monitor photodiode 14 supplies the monitor current Im to the shunt resistor R. Therefore, the inter-terminal voltage applied across the shunt resistor R is proportional to the monitor current Im (monitor voltage Vm).

The shunt resistor R is connected to a first sample-and-hold (S/H) circuit 15, which serves as extinguishment monitoring means, a second sample-and-hold (S/H) circuit 16, which serves as illumination monitoring means, and a low-pass filter (LPF) 16, which serves as average intensity acquisition means. Therefore, the monitor voltage Vm, which is proportional to the monitor current Im, is supplied to the first S/H circuit 15, second S/H circuit 16, and LPF 17.

The first S/H circuit 15 samples the OFF level monitor voltage Vm (first monitor value) that corresponds to a state where the laser diode 11 is extinguished. The first S/H circuit 15 is connected to a bias current feedback circuit 18 and a duty feedback circuit 20 to supply the sampled monitor voltage Vm to these feedback circuits

The second S/H circuit 16 samples the ON level monitor voltage Vm (second monitor value) that corresponds to a state where the laser diode 11 is illuminated. The second S/H circuit 16 is connected to an illumination current feedback circuit 19 and the duty feedback circuit 20 to supply the sampled monitor voltage Vm to these feedback circuits.

A low-pass filter 17 acquires an average value of the monitor voltage Vm (monitor average value AVE). The low-pass filter 17 is connected to the duty feedback circuit 20. The low-pass filter 17 supplies the acquired monitor average value AVE to the duty feedback circuit 20 as a monitor average value signal Vave.

The bias current feedback circuit 18 is connected to the bias current drive circuit 12. In accordance with the OFF level monitor voltage Vm that is supplied from the first S/H circuit 15 and corresponds to the extinguishment state, the bias current feedback circuit 18 performs feedback on the value of the bias current Ib so that the bias current Ib coincides with the threshold current. More specifically, the bias current feedback circuit 18 determines the bias current Ib that coincides with the threshold current, and supplies to the bias current drive circuit 12 the first control signal CS1, which serves as a reference current for causing the bias current drive circuit 12 to output the determined bias current Ib.

The illumination current feedback circuit 19 is connected to the data current drive circuit 13. In accordance with the ON level monitor voltage Vm that is supplied from the second S/H circuit 16 and corresponds to the illumination state, the illumination current feedback circuit 19 performs feedback on the value of the illumination current Ip so as to obtain a specified intensity of light emission. More specifically, the illumination current feedback circuit 19 determines the illumination current Ip so as to obtain the specified intensity of light emission, and supplies to the data current drive circuit 13 the second control signal CS2, which is a reference current for causing the data current drive circuit 13 to output the determined illumination current Ip.

The OFF level monitor voltage Vm that is output from the first S/H circuit 15, the ON level monitor voltage Vm that is output from the second S/H circuit 16, and the monitor average value signal Vave that is output from the low-pass filter 17 are input into the duty feedback circuit 20. The duty feedback circuit 20 performs feedback to obtain a normal duty ratio. Duty ratio data is recorded in the duty feedback circuit 20. The present embodiment uses a duty ratio of 50% as the normal duty ratio. The data about a duty ratio of 50% is recorded in the duty feedback circuit 20. The duty feedback circuit 20 exercises control so that the monitor average value AVE based on the monitor average value signal Vave is an intermediate value of the monitor voltage Vm.

More specifically, the duty feedback circuit 20 calculates an intermediate value between the OFF level monitor voltage Vm, which corresponds to the extinguishment state, and the ON level monitor voltage Vm, which corresponds to the illumination state. In accordance with the intermediate value and monitor average value signal Vave, the duty feedback circuit 20 then generates a duty ratio control signal DSC. More specifically, the duty feedback circuit 20 generates the duty ratio control signal DSC so that the voltage value based on the monitor average value signal Vave (monitor average value AVE) is an intermediate value between the OFF level and ON level monitor voltages Vm.

The duty feedback circuit 20 is connected to the duty control circuit 21 to supply the generated duty ratio control signal DSC to the duty control circuit 21.

In accordance with the duty ratio control signal DSC, the duty control circuit 21 controls data Txc in relation to data Tx. More specifically, the duty control circuit 21 complies with the duty ratio control signal DSC and outputs data Txc in relation to the entered data Tx so that the duty ratio is 50%. In the present embodiment, therefore, the duty feedback circuit 20 and duty control circuit 21 constitute the control means that is defined in the appended claims.

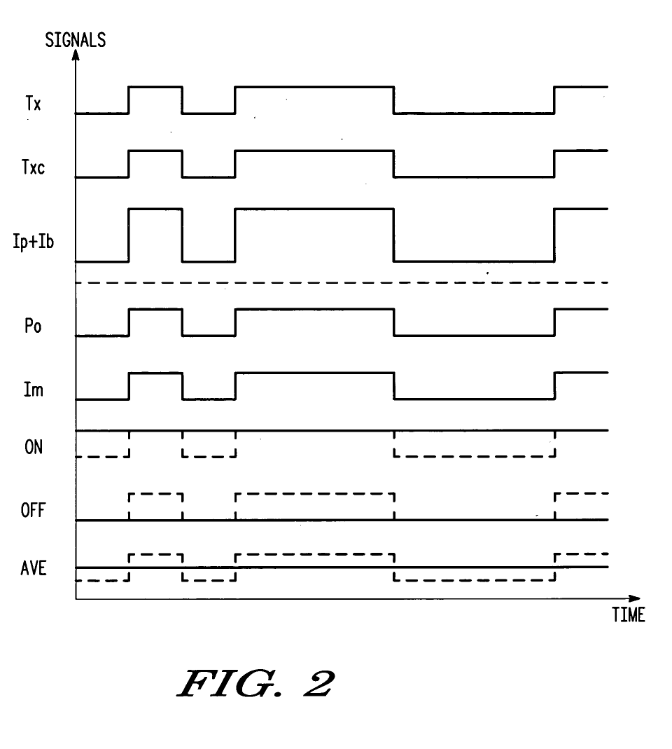

Timing diagrams shown in FIGS. 2 through 4 will now be used for explanation purposes. As shown in FIG. 2, data Tx first enters the duty control circuit 21. Data Tx is a pulse signal having a specified pulse width. In accordance with data Tx, the duty control circuit 21 supplies data Txc to the data current drive circuit 13. The data current drive circuit 13 supplies the illumination current Ip to the laser diode 11 in compliance with data Txc. The laser diode then illuminates in accordance with the illumination current Ip. As a result, the monitor photodiode 14 receives an optical output Po.

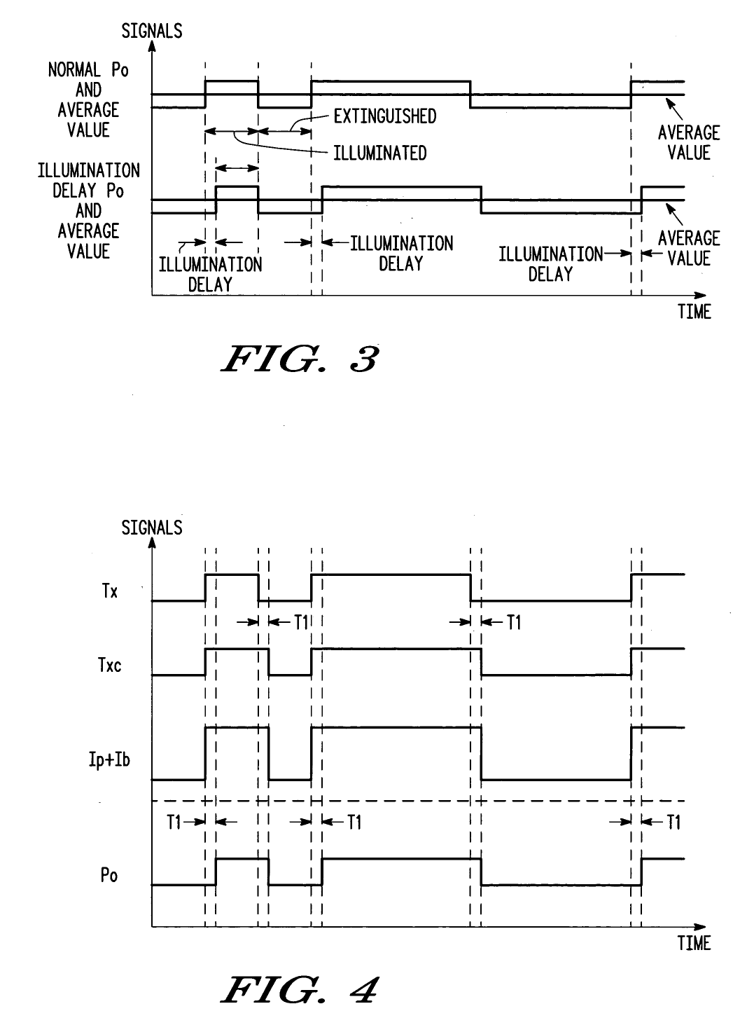

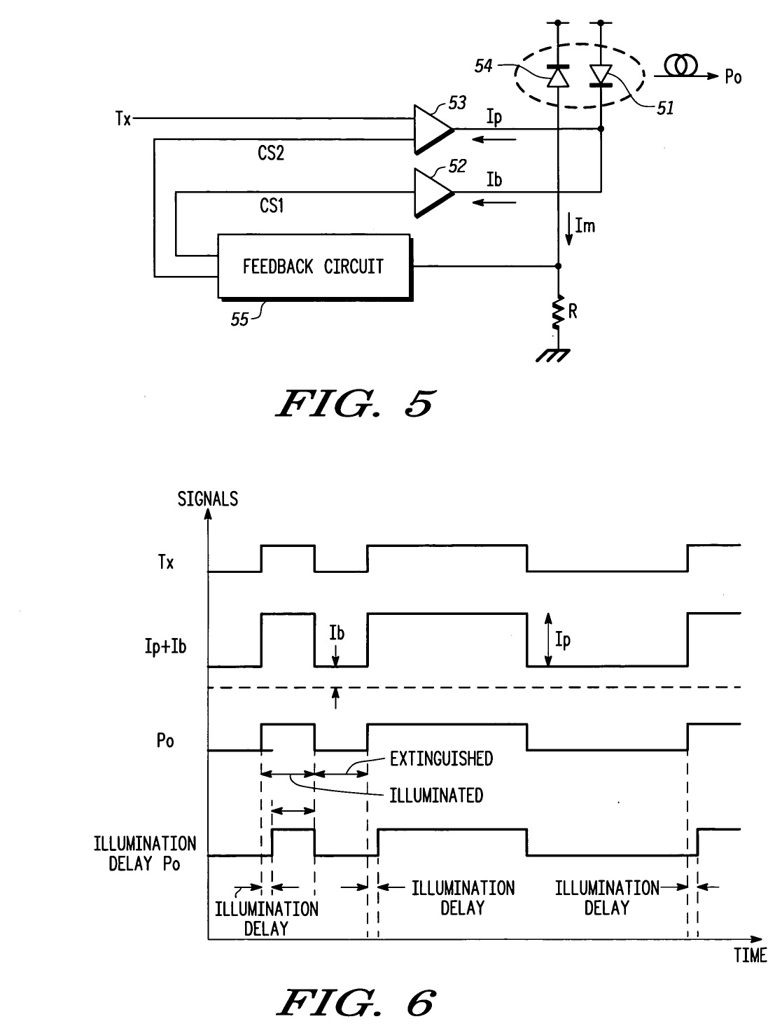

Upon receipt of the optical output Po, the monitor photodiode 14 outputs the monitor current Im. As a result, the first S/H circuit 15 outputs an OFF voltage, and the second S/H circuit 16 outputs an ON voltage. The LPF 17 outputs the monitor average value signal Vave concerning the monitor average value AVE. When the duty ratio is 50%, the intermediate value between the ON voltage and OFF voltage coincides with the monitor average value AVE as shown in FIG. 3.

It is now assumed that the illumination characteristic of the laser diode 11 is changed due to aging or other cause. More specifically, it is assumed that the illumination of the laser diode 11 does not follow the illumination current Ip, which is based on data Txc, and suffers an illumination delay T1 as shown in FIG. 3. In this instance, the waveform of the optical output Po becomes thin. The extinguishment time is then shorter than the illumination time by the illumination delay T1. Consequently, the duty ratio is smaller than 50%.

The duty feedback circuit 20 detects that the intermediate value and monitor average value AVE do not coincide with each other, and then supplies the duty ratio control signal DSC for compensating for the illumination delay T1 to the duty control circuit 21. The duty ratio control signal DSC contains information concerning the illumination delay T1. The duty ratio control signal DSC is complied with so as to control data Txc in relation to data Tx. More specifically, the duty control circuit 21 extends the ON level period of data Txc by the illumination delay T1 as shown in FIG. 4. In other words, data Txc turns out to be a waveform having a greater High-level width than data Tx.

While the High level of data Txc is being input, the data current drive circuit 13 outputs the illumination current Ip. Consequently, the illumination current Ip turns out to be a waveform that has a great High-level width for a period based on the duty ratio control signal DSC, as is the case with data Txc.

The laser diode 11 illuminates in accordance with the illumination current Ip. If the laser diode 11 suffers an illumination delay (illumination delay T1), it illuminates when a period equivalent to the illumination delay (illumination delay T1) elapses after the illumination current Ip is supplied to the laser diode 11. The laser diode 11 becomes extinguished when the supply of the illumination current IP comes to an end. As described above, the waveform of the illumination current Ip has an increased High-level width in accordance with the duty ratio control signal DSC corresponding to the illumination delay T1. Therefore, the laser diode 11 illuminates with a delay that is equivalent to the illumination delay. However, the period of laser diode illumination is the same as the normal one.

The features of the laser diode drive circuit, which is configured as described above, will now be described. In the present embodiment, the first S/H circuit 15 acquires a monitor voltage Vm (OFF level) that prevails while the laser diode 11 is extinguished, the second S/H circuit 16 acquires a monitor voltage Vm (ON level) that prevails while the laser diode 11 is illuminated, and the LPF 17 acquires a monitor average value AVE. The duty feedback circuit 20 calculates the intermediate value (normal average value) from the OFF level monitor voltage Vm, ON level monitor voltage Vm, and duty ratio (50%), and outputs the duty ratio control signal DSC so that the monitor average value AVE coincides with the normal average value. The duty control circuit 21 controls the illumination current Ip by controlling the waveform of data Txc in compliance with the duty ratio control signal DSC.

Therefore, even when the illumination timing changes due to a change in the illumination characteristic of the laser diode 11, the normal duty ratio can be maintained. In the present embodiment, the duty feedback circuit 20 changes the illumination time of the laser diode 11 so that the monitor average value AVE coincides with the intermediate value (normal average value). Therefore, the illumination time of the laser diode can be adjusted so that the monitor average value AVE coincides with the normal average value.

In the present embodiment, the intensity of light emission from the laser diode 11 is controlled by controlling the data current drive circuit 13 for the purpose of controlling the illumination current Ip in accordance with the ON level monitor voltage Vm acquired by the second S/H circuit 16. Therefore, the intensity of light emission from the laser diode 11 can be controlled in accordance with the monitor voltage Vm that prevails when the laser diode 11 is illuminated.

In the present embodiment, the bias current Ib is controlled by controlling the bias current drive circuit 12 in accordance with the OFF level monitor voltage Vm acquired by the first S/H circuit 15. Therefore, the bias current Ib can be controlled in accordance with the monitor voltage Vm that prevails when the laser diode 11 is extinguished.

The present invention is not limited to the foregoing embodiment, but is applicable to the following modifications. The foregoing embodiment is applied to a drive circuit for a laser diode, which is used as a light-emitting element. Alternatively, however, the embodiment may be applied to a drive circuit for a light-emitting diode or other light-emitting element.

The foregoing embodiment is applied to a photodiode, which is used as a light-emitting element. Alternatively, however, the embodiment may be applied to a phototransistor or other light-emitting element. In the foregoing embodiment, it is assumed that a desired duty ratio is 50%. Alternatively, however, the desired duty ratio can be any value. When the duty feedback circuit 20 outputs a duty ratio control signal DSC so as to obtain a desired duty ratio, an optical waveform with the desired duty ratio can be obtained no matter what the desired duty ratio is.

In the foregoing embodiment, a desired duty ratio (50%) is predetermined. Alternatively, however, the duty feedback circuit 20 may include duty ratio acquisition means so as to use a duty ratio that is acquired by the duty ratio acquisition means. The setting for a desired duty ratio can then be changed depending on the situation.

In the foregoing embodiment, a shunt resistor is used for measuring the voltage. However, if the data about the intensity of light emission can be obtained, the voltage may be measured by an alternative method. For example, the electrical current of a light-emitting element may be directly measured.

In the foregoing embodiment, the first S/H circuit 15 and second S/H circuit 16 are used. However, these circuits may be substituted, for instance, by peak hold circuits.

Description of the Symbols
AVE: Monitor average value
Im: Monitor current
Ib: Bias current
Ip: Illumination current
Po: Optical output
Vm: Monitor voltage
11: Laser diode for use as a light-emitting element
12: Bias current drive circuit for use as bias drive means
13: Data current drive circuit for use as light-emitting element drive means
14: Monitor photodiode for use as a detection light-sensitive element
15: First S/H circuit for use as extinguishment monitoring means
16: Second S/H circuit for use as illumination monitoring means
17: Low-pass filter for use as average intensity acquisition means
20: Duty feedback circuit for use as control means
21: Duty control circuit for use as control means

1. A light-emitting element drive circuit in which light-emitting element drive means for driving a light-emitting element in accordance with an input signal is provided and duty ratio data is recorded, the light-emitting element drive circuit comprising:
a detection light-sensitive element for detecting the intensity of light emission from said light-emitting element and outputting a detection signal in accordance with the detected intensity;
extinguishment monitoring means for acquiring a first monitor value, which represents a detection signal that is generated when said light-emitting element is extinguished;
illumination monitoring means for acquiring a second monitor value, which represents a detection signal that is generated when said light-emitting element is illuminated;
average intensity acquisition means for acquiring a monitor average value of detection signals of said light-emitting element; and
control means for calculating a normal average value from said first monitor value, said second monitor value, and said duty ratio, and controlling said light-emitting element drive means so that said monitor average value coincides with said normal average value.

2. The light-emitting element drive circuit according to claim 1, wherein said control means changes the illumination time of said light-emitting element so that said monitor average value coincides with said normal average value.

3. The light-emitting element drive circuit according to claim 1, wherein said light-emitting element drive means is controlled in accordance with the second monitor value acquired by said illumination monitoring means to control the intensity of light emission from said light-emitting element.

4. The light-emitting element drive circuit according to claim 1, further comprising:
bias drive means for outputting a bias current to said light-emitting element,
wherein said bias drive means is controlled in accordance with the first monitor value acquired by said illumination monitoring means to control said bias current.

5. The light-emitting element drive circuit according to claim 1, further comprising duty ratio acquisition means for acquiring duty ratio data.
